(19) United States
(12) Patent Application Publication
(10) Pub. No.: US 2017/0276981 A1
(43) Pub. Date: Sep. 28, 2017

(54) TRANSFER PLATE WETTING SYSTEM AND ALIGNMENT LIQUID TRANSFER SYSTEM

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventors: Xianfeng ZHENG, Beijing (CN); Yangkun JING, Beijing (CN)

(21) Appl. No.: 15/509,069

(22) PCT Filed: Aug. 31, 2016
(86) PCT No.: PCT/CN2016/097598

§ 371 Date: Mar. 6, 2017

(30) Foreign Application Priority Data
Nov. 2, 2015 (CN) 201510734300.7

(51) Int. Cl. G02F 1/1337; B41F 7/36

(52) U.S. Cl. CPC G02F 1/1337; B41F 7/36

(57) ABSTRACT

A transfer plate wetting system and an alignment liquid transfer system are provided. The transfer plate wetting system includes a first plate wetting device. The first plate wetting device includes an alignment agent storage tank (7), an alignment agent solvent storage tank (8), a nozzle (10) and a pipeline connector (T) configured for communicating the alignment agent storage tank (7), the alignment agent solvent storage tank (8) and the nozzle (10). The nozzle (10) is configured to spray out alignment liquid including an alignment agent and an alignment agent solvent. The transfer plate wetting system is capable of forming alignment layer with uniform thickness, thus improving display effect of display device.

### TECHNICAL FIELD

Embodiments of the present disclosure relate to a transfer plate wetting system and an alignment liquid transfer system.

### BACKGROUND

In a related art, as shown in FIG. 1, an alignment liquid transfer device for making an alignment layer in a display apparatus includes mechanisms as follows: a spray needle 1, a scraper 2, a transfer roller 3, a transfer plate (Asahikasei Photosensitive Resin Plate, APR plate in short) 4, a printing roller 5 and a display substrate carrying table 6. The process of transferring alignment liquid to a display substrate by using the alignment liquid transfer device is as follows: the spray nozzle 1 sprays the alignment liquid to the transfer roller 3, and then the transfer roller 3 rotates to take away the alignment liquid; at the same time, the scraper 2 uniformly scrapes the alignment liquid on the transfer roller 3, then the transfer roller 3 is in contact with the transfer plate 4 wrapped on the printing roller 5, the alignment liquid on the transfer roller 3 is transferred onto the transfer plate 4 by a pressure between the transfer roller 3 and the transfer plate 4, then the printing roller 5 moves above the display substrate, and the alignment liquid is transferred onto the display substrate by a pressure between the transfer plate 4 and the display substrate.

In the related art, before the transfer plate 4 is loaded to a machine (i.e., the transfer plate 4 is wrapped on the printing roller 5), the transfer plate 4 needs to be soaked in the alignment liquid for a period of time to absorb the alignment liquid and swell, so that hardness of the transfer plate 4 is reduced, and then in the subsequent process of transferring the alignment liquid to the transfer plate 4 wrapped on the printing roller 5 by the transfer roller 3, the transfer plate 4 can be deformed a lot and grooves densely distributed on the transfer plate 4 can accumulate more alignment liquid to form an alignment layer with a proper thickness on the display substrate.

### SUMMARY

An embodiment of the present disclosure provides a transfer plate wetting system, including a first plate wetting device, the first plate wetting device including an alignment agent storage tank, an alignment agent solvent storage tank, a nozzle and a pipeline connector for communicating the alignment agent storage tank, the alignment agent solvent storage tank and the nozzle, the nozzle being configured to spray out alignment liquid including an alignment agent and an alignment agent solvent.

An embodiment of the present disclosure provides an alignment liquid transfer system, including the transfer plate wetting system as described above and an alignment liquid transfer device, wherein the alignment liquid transfer device includes a transfer plate and a printing roller, the transfer plate is configured to be wrapped on the printing roller, and the alignment liquid transfer device is configured to transfer the alignment liquid on the transfer plate onto a display substrate to be subjected to transfer printing.

### BRIEF DESCRIPTION OF THE DRAWINGS

In order to clearly illustrate the technical solution of the embodiments of the disclosure or the prior art, the drawings of the embodiments or description in the prior art will be briefly described in the following. It is obvious that the described drawings are only related to some embodiments of the disclosure, and those skilled in the art also can obtain other drawings, without any inventive work, according to the drawings.

FIG. 1 is a structural schematic diagram of an alignment liquid transfer device;

FIG. 2 is a structural schematic diagram of a first kind front plate wetting device in an embodiment of the present disclosure;

FIG. 3 is a structural schematic diagram of a second kind front plate wetting device in an embodiment of the present disclosure;

FIG. 4 is a structural schematic diagram of a third kind front plate wetting device in an embodiment of the present disclosure;

FIG. 5 is a structural schematic diagram of a fourth kind front plate wetting device in an embodiment of the present disclosure;

FIG. 6 is a structural schematic diagram of a fifth kind front plate wetting device in an embodiment of the present disclosure;

FIG. 7 is a structural schematic diagram of a sixth kind front plate wetting device in an embodiment of the present disclosure;

FIG. 8 is a structural schematic diagram of a seventh kind front plate wetting device in an embodiment of the present disclosure;

FIG. 9 is a structure schematic diagram of a first kind rear plate wetting device in an embodiment of the present disclosure;

FIG. 10 is a schematic diagram of a rear plate wetting device and an alignment liquid transfer device in an embodiment of the present disclosure;

FIG. 11 is a structure schematic diagram of a second kind rear plate wetting device in an embodiment of the present disclosure;

FIG. 12 is a structure schematic diagram of a third kind rear plate wetting device in an embodiment of the present disclosure.

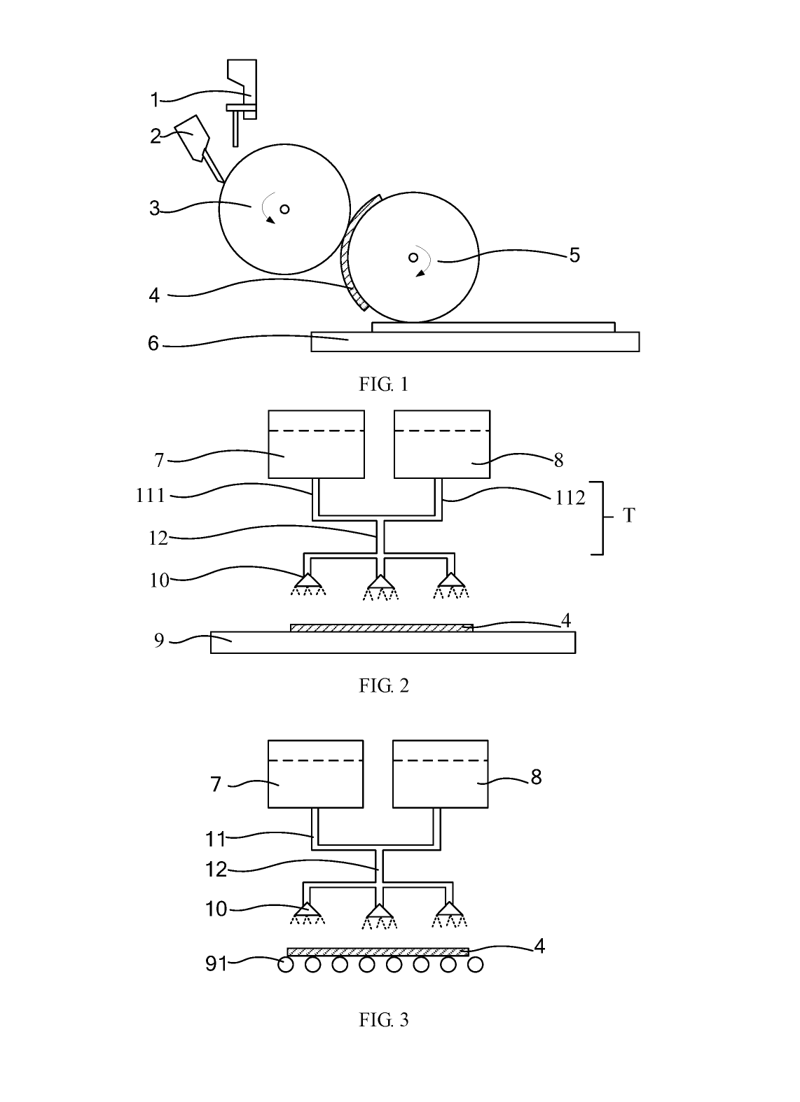

### DETAILED DESCRIPTION

The inventors find that alignment liquid includes an alignment agent (e.g., polyimide) and an alignment agent solvent (e.g., N-methyl pyrrolidone), wherein the alignment agent is difficult to volatilize and the alignment agent solvent is easy to volatilize, and thus, in the process of soaking a transfer plate 4, concentration of the alignment liquid will be gradually increased, and after the concentration of the alignment liquid is increased to a certain degree, the alignment agent will be separated out and the separated alignment agent will be adsorbed to the transfer plate 4 to form particles, so that in the subsequent process that the transfer plate 4 transfers the alignment liquid onto a display substrate, the particles will be separated from the transfer plate 4 to be attached to the display substrate. In the drying process of the alignment liquid on the display substrate, a thickness of the particles formed by the alignment agent will not be reduced, but the alignment agent solvent at other positions will be volatilized, so that an alignment layer at the position where the particles are attached has a relatively large thickness, which causes an uneven thickness of the alignment layer, thereby causing a poor display effect of a display apparatus.

An embodiment of the present disclosure provides a transfer plate wetting system and alignment liquid transfer system, capable of producing an alignment layer with a uniform thickness and improving the display effect of a display apparatus.

The technical solution of the embodiments will be described in a clearly and fully understandable way in connection with the drawings related to the embodiments of the disclosure. It is obvious that the described embodiments are just a part but not all of the embodiments of the disclosure. Based on the embodiments of the disclosure, those skilled in the art can obtain other embodiment(s), without any inventive work, which should be within the scope of protection of the disclosure.

An embodiment of the present disclosure provides a transfer plate wetting system including a front plate wetting device (i.e., a first plate wetting device). As shown in FIG. 2, the front plate wetting device includes an alignment agent storage tank 7, an alignment agent solvent storage tank 8, a transfer plate conveying unit 9 and a nozzle 10 arranged above the transfer plate conveying unit 9. A liquid outlet of the alignment agent storage tank 7 and a liquid outlet of the alignment agent solvent storage tank 8 are connected to one end of a liquid mixing pipeline 12 respectively by a first liquid outlet pipeline 111 and a second liquid outlet pipeline 112, and the other end of the liquid mixing pipeline 12 is connected with the nozzle 10. The nozzle 10 is configured to spray alignment liquid including an alignment agent and an alignment agent solvent.

The combination of the first liquid outlet pipeline 111, the second liquid outlet pipeline 112 and the liquid mixing pipeline 12 forms a pipeline connector for communicating the alignment agent storage tank, the alignment agent solvent storage tank and the nozzle.

The liquid outlet of the alignment agent storage tank 7 and the liquid outlet of the alignment agent solvent storage tank 8 can be connected to one end of the same liquid mixing pipeline 12 respectively by the first liquid outlet pipeline 111 and the second liquid outlet pipeline 112, so that the alignment agent and the alignment agent solvent are more uniformly mixed. In addition, the front plate wetting device can include a plurality of nozzles 10, so that the alignment liquid sprayed onto the transfer plate 4 by the nozzles 10 is more uniform.

The liquid outlet of the alignment agent storage tank 7 and the liquid outlet of the alignment agent solvent storage tank 8 are connected to one end of the liquid mixing pipeline 12 respectively by the first liquid outlet pipeline 111 and the second liquid outlet pipeline 112, and the other end of the liquid mixing pipeline 12 is connected with the nozzle 10 arranged above the transfer plate conveying unit 9, and thus, the alignment agent and the alignment agent solvent can be mixed in the liquid mixing pipeline 12 to form the alignment liquid, so that the alignment liquid can be isolated from the outside by the liquid mixing pipeline 12, and moreover, the alignment liquid can be sprayed in real time onto the transfer plate 4 by the nozzle 10 to carry out plate wetting on the transfer plate 4, and exposure time of the alignment liquid in the air is relatively short, so that volatilization of the alignment agent solvent is avoided and separation-out of the alignment agent is prevented, and thus, particles will not be formed on the transfer plate 4, which avoids the problem that in the transferring process of the alignment liquid, the particles are separated from the transfer plate 4 to be attached to a display substrate, is beneficial for producing an alignment layer with a uniform thickness and improves the display effect of a display apparatus.

As shown in FIG. 3, the transfer plate conveying unit 9 can include a plurality of conveying rollers 91, rotating shafts of the plurality of conveying rollers 91 are in parallel with each other, and supporting surfaces of the plurality of conveying rollers 91 are positioned on a same plane. For example, in the conveying process of the transfer plate 4, the transfer plate 4 is placed on the plurality of conveying rollers 91, and each conveying roller 91 rotates to drive the transfer plate 4 to move, so that the transfer plate 4 is relatively steady conveyed by the transfer plate conveying unit 9, and mechanical damage to the transfer plate 4 in the conveying process can be effectively prevented.

It should be noted that a specific structure of the transfer plate conveying unit 9 is not limited to the above, those skilled in the art can select according to actual demands, and the specific structure of the transfer plate conveying unit 9 is not repeated in the embodiments of the present disclosure.

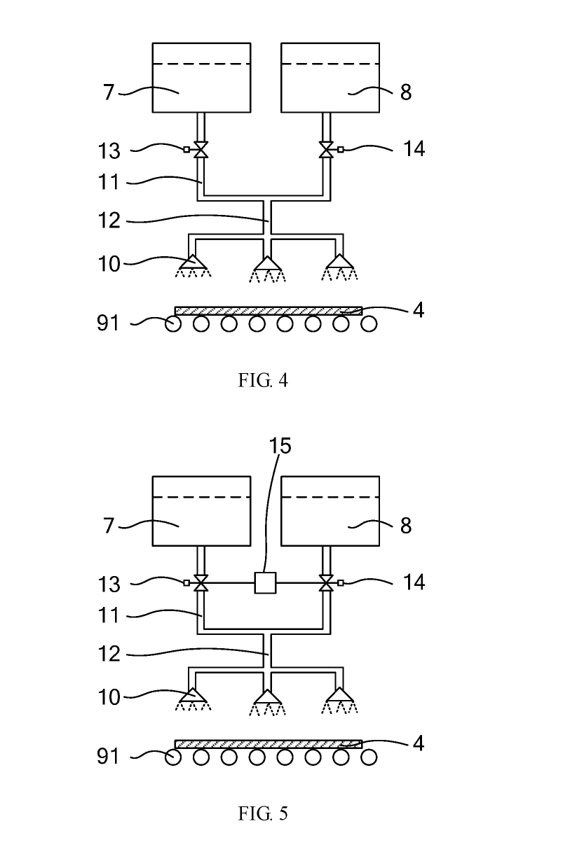

In addition, as shown in FIG. 4, the front plate wetting device further can include an alignment agent flow regulator 13 and an alignment agent solvent flow regulator 14. The alignment agent flow regulator 13 is arranged on a liquid outlet pipeline between the liquid outlet of the alignment agent storage tank 7 and the liquid mixing pipeline 12, and the alignment agent solvent flow regulator 14 is arranged on a liquid outlet pipeline between the liquid outlet of the alignment agent solvent storage tank 8 and the liquid mixing pipeline 12, so that the alignment agent flow regulator 13 can regulate flow of the alignment agent, and the alignment agent solvent flow regulator 14 can regulate flow of the alignment agent solvent. Moreover, by respectively regulating the flow of the alignment agent and the flow of the alignment agent solvent by the alignment agent flow regulator 13 and the alignment agent solvent flow regulator 14, different concentration of alignment liquid can be obtained to match with different plate wetting process parameters.

Further, as shown in FIG. 5, the front plate wetting device further can include a controller 15, and the controller 15 is connected with the alignment agent flow regulator 13 and the alignment agent solvent flow regulator 14. Therefore, a production staff can simultaneously control the alignment agent flow regulator 13 and the alignment agent solvent flow regulator 14 only by carrying out a corresponding operation on the controller 15, so that operation time is saved.

Exemplarily, the controller 15 includes a programmable logic control unit and a touch display panel, wherein an input end of the programmable logic control unit is connected with the touch display panel, an output end of the programmable logic control unit is respectively connected with the alignment agent flow regulator 13 and the alignment agent solvent flow regulator 14, and the programmable logic control unit is configured for sending instructions to the alignment agent flow regulator 13 and the alignment agent solvent flow regulator 14; and the touch display panel can be configured for displaying information of the alignment agent flow regulator 13 and information of the alignment agent solvent flow regulator 14, so that the production staff can visually know working conditions of the alignment agent flow regulator 13 and the alignment agent solvent flow regulator 14. For example, the information of the alignment agent flow regulator 13 and the information of the alignment agent solvent flow regulator 14 are both displayed on the touch display panel in a chart form, wherein the information of the alignment agent flow regulator 13 includes the flow of the alignment agent, and the information of the alignment agent solvent flow regulator 14 includes the flow of the alignment agent solvent. Therefore, when the flow of the alignment agent or the flow of the alignment agent solvent is abnormal (for example, due to blockage of one liquid outlet pipeline, the flow of corresponding liquid is lower than a preset value), the production staff can timely find the abnormity so as to effectively avoid change of the concentration of the alignment liquid in the liquid mixing pipeline 12.

Herein, the “carrying out a corresponding operation on the controller 15” means that: a related instruction is input by the touch display panel, the related instruction is transmitted to the programmable logic control unit, and then the programmable logic control unit respectively sends control instructions to the alignment agent flow regulator 13 and the alignment agent solvent flow regulator 14 according to the related instruction so as to control the alignment agent flow regulator 13 and the alignment agent solvent flow regulator 14.

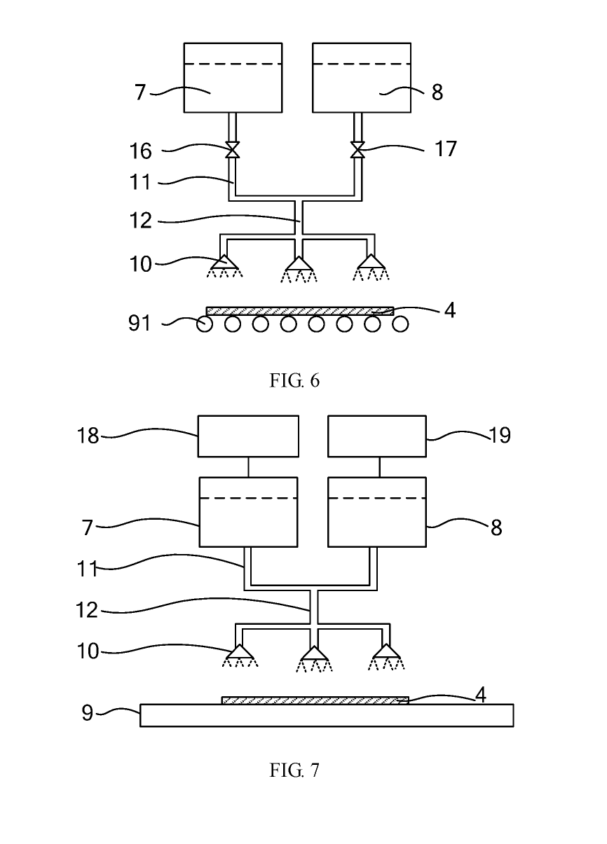

In addition, as shown in FIG. 6, the front plate wetting device further can include an alignment agent storage tank valve 16 and an alignment agent solvent storage tank valve 17. The alignment agent storage tank valve 16 is arranged on the liquid outlet pipeline between the liquid outlet of the alignment agent storage tank 7 and the liquid mixing pipeline 12, and the alignment agent solvent storage tank valve 17 is arranged on the liquid outlet pipeline between the liquid outlet of the alignment agent solvent storage tank 8 and the liquid mixing pipeline 12, and thus, by using the alignment agent storage tank valve 16 and the alignment agent solvent storage tank valve 17, the two liquid outlet pipelines can be accurately controlled to be switched on and off.

In addition, as shown in FIG. 7, the front plate wetting device further can include a first liquid level sensor 18 connected with the alignment agent storage tank 7 and a second liquid level sensor 19 connected with the alignment agent solvent storage tank 8, so that the production staff can monitor a liquid level height of the alignment agent storage tank 7 and a liquid level height of the alignment agent solvent storage tank 8 in real time. When the liquid level height of the alignment agent storage tank 7 or the liquid level height of the alignment agent solvent storage tank 8 is relatively low, the production staff can timely add the corresponding liquid into the alignment agent storage tank 7 or the alignment agent solvent storage tank 8 so as to prevent change of the concentration of the alignment liquid due to insufficiency of the alignment agent or the alignment agent solvent; and when the liquid level height of the alignment agent storage tank 7 or the liquid level height of the alignment agent solvent storage tank 8 is relatively high, the production staff can timely stop adding the corresponding liquid into the alignment agent storage tank 7 or the alignment agent solvent storage tank 8 so as to prevent overflow of the excessive alignment agent or alignment agent solvent out of the corresponding storage tank and save production cost.

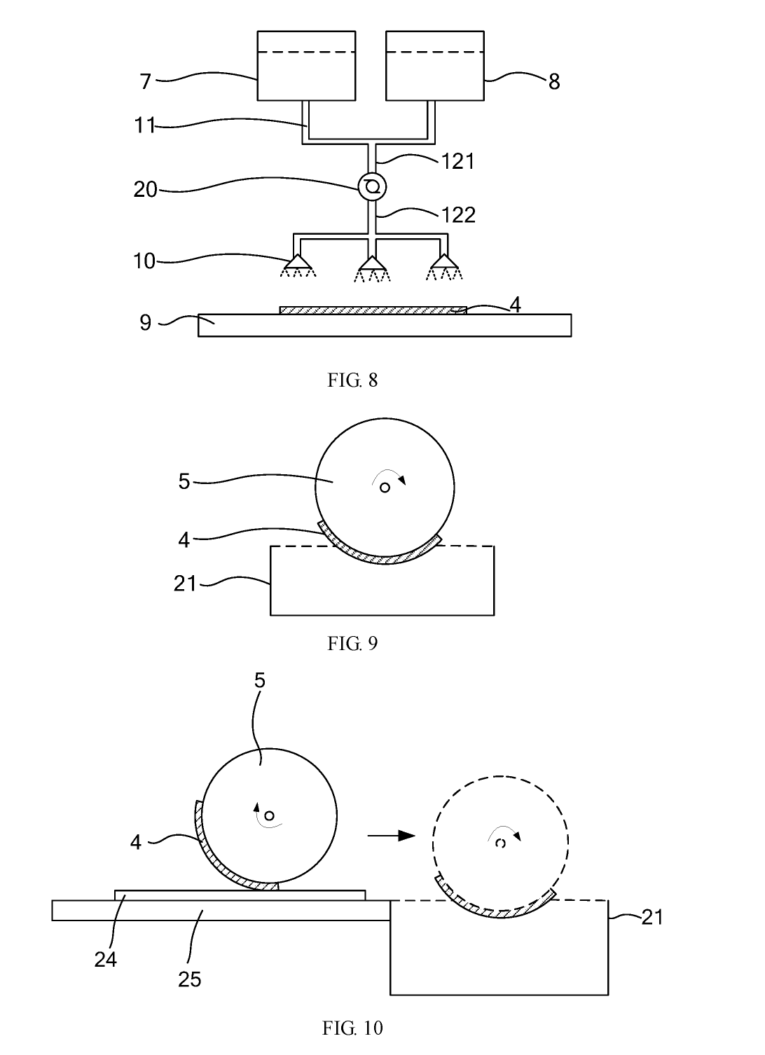

In addition, as shown in FIG. 8, the front plate wetting device further can include a pump 20, the liquid mixing pipeline 12 includes a first sub liquid mixing pipeline 121 and a second sub liquid mixing pipeline 122, both the liquid outlet of the alignment agent storage tank 7 and the liquid outlet of the alignment agent solvent storage tank 8 are connected to an inlet end of the first sub liquid mixing pipeline 121, an outlet end of the first sub liquid mixing pipeline 121 is connected to a suction inlet of the pump 20, a discharge port of the pump 20 is connected to an inlet end of the second sub liquid mixing pipeline 122, and an outlet end of the second sub liquid mixing pipeline 122 is connected to the nozzle 10. For example, the alignment agent in the alignment agent storage tank 7 and the alignment agent solvent in the alignment agent solvent storage tank 8 enter the liquid mixing pipeline 12 from the corresponding liquid outlet pipelines to form the alignment liquid, then the alignment liquid is sent to the nozzle 10 by a pressure provided by the pump 20; then, the alignment liquid is sprayed from the nozzle 10 at a certain speed, and the sprayed alignment liquid is excellent in dispersion effect, so that the alignment liquid can be uniformly sprayed to the transfer plate 4, and thus, a plate wetting effect of the transfer plate 4 is good. Herein, the controller 15 not only is connected with the alignment agent flow regulator 13 and the alignment agent solvent flow regulator 14, but also can be respectively connected with the pump 20 and the nozzle 10, so that the controller 15 can control a plurality of devices, thereby facilitating operation of the production staff and improving production efficiency.

In addition, the inventors find that, in the related art, after an alignment liquid transfer device completes transfer printing on one display substrate, a transfer plate 4 wrapped on a printing roller 5 is exposed in the air, and then alignment liquid on the transfer plate 4 is exposed in the air, and thus, in this process, separation-out of the alignment agent, which is caused by volatilization of the alignment agent solvent, also can occur, the alignment agent separated out will be adsorbed to the transfer plate 4 to form particles, and then in the subsequent process that the transfer plate 4 transfers the alignment liquid onto the display substrate, the particles will be separated from the transfer plate 4 to be attached to the display substrate to cause an uneven thickness of a finally formed alignment layer, so that the display effect of the display apparatus is poor.

In order to avoid the above problem, in addition to the above-mentioned front plate wetting device, the transfer plate wetting system provided by the embodiment of the present disclosure further can include a rear plate wetting device, and the rear plate wetting device can be matched with an alignment liquid transfer device for use. As shown in FIG. 9, the rear plate wetting device includes an infiltration liquid storage tank 21, so that as shown in FIG. 10, after the alignment liquid transfer device completes transfer printing on one display substrate 24 to be subjected to transfer printing, the transfer plate 4 on a printing roller 5 included in the alignment liquid transfer device can be soaked in infiltration liquid in the infiltration liquid storage tank 21, thereby implementing infiltration on the transfer plate 4.

Optionally, the infiltration liquid includes the alignment agent solvent. It should be noted that the infiltration liquid can only include the alignment agent solvent, or also can include the alignment agent and the alignment agent solvent. Due to relatively high cost of the alignment agent and relatively low cost of the alignment agent solvent, in order to save production cost, the infiltration liquid in the embodiment of the present disclosure can only include the alignment agent solvent.

In addition, an embodiment of the present disclosure further provides an alignment liquid transfer system. The alignment liquid transfer system includes the above described transfer plate wetting system, and an alignment liquid transfer device configured for transferring alignment liquid to the display substrate 24 to be subjected to transfer printing. As shown in FIG. 10, the alignment liquid transfer device includes a transfer plate 4 and the printing roller 5 for transferring the alignment liquid on the transfer plate 4 to the display substrate 24 to be subjected to transfer printing. In the operation process, the transfer plate 4, for example, is wrapped on the printing roller 5, and is infiltrated by the alignment liquid sprayed out by the nozzle 10. The alignment liquid transfer system includes the above-mentioned transfer plate wetting system, and thus, the alignment liquid transfer system has the same advantageous effects with the above-mentioned transfer plate wetting system, which is not repeated herein.

In another embodiment, the alignment liquid transfer system further includes an infiltration liquid storage tank for accommodating infiltration liquid. After the alignment liquid transfer device completes transfer printing on one display substrate 24 to be subjected to transfer printing, the printing roller 5 soaks the transfer plate 4 in the infiltration liquid in the infiltration liquid storage tank to carry out infiltration.

In order to further improve an infiltration effect of the transfer plate and improve the display effect of the display apparatus, when the transfer plate 4 is soaked in the infiltration liquid, the printing roller 5 also can rotate, so that all positions of the transfer plate 4 can be infiltrated by the infiltration liquid.

Further, as shown in FIG. 10, the alignment liquid transfer device provided by the embodiment of the present disclosure further includes a carrying table 25 for placing the display substrate 24 to be subjected to transfer printing, and the infiltration liquid storage tank 21 is arranged on a transfer termination end side of the carrying table 25. Therefore, after the printing roller 5 completes transfer printing on one display substrate 24 to be subjected to transfer printing, the printing roller 5 can reach a position of the infiltration liquid storage tank 21 positioned on the termination end side of the carrying table 25 by moving for a very short distance, so that production time is saved.

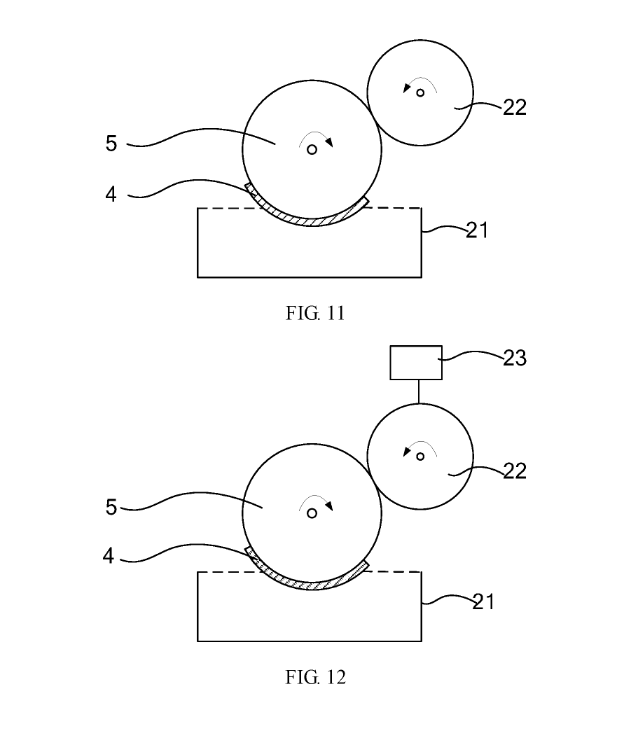

In addition, as shown in FIG. 11, the rear plate wetting device further can include a uniforming roller 22. For example, after the alignment liquid transfer device completes transfer printing on one display substrate 24 to be subjected to transfer printing, the uniforming roller 22 is tangent to the printing roller 5. By mutual extrusion of the uniforming roller 22 and the transfer plate 4 wrapped on the printing roller 5, the transfer plate 4 is uniformly infiltrated by the infiltration liquid. It should be noted that the uniforming roller 22 included in the rear plate wetting device in the embodiment of the present disclosure is another structure independent of a transfer roller in the alignment liquid transfer device. Certainly, the alignment liquid transfer device in the embodiment of the present disclosure also can include the uniforming roller, so that the alignment liquid transfer device has a better transfer effect.

Further, the inventors of the present application find that when a press-in amount of the uniforming roller 22 on the transfer plate 4 is relatively small, deformation of the transfer plate 4 is relatively small, the infiltration liquid may not enter grooves densely distributed on the transfer plate 4, and the particles cannot be dissolved by the infiltration liquid; and when the press-in amount of the uniforming roller 22 on the transfer plate 4 is relatively large, deformation of the transfer plate 4 is relatively large, which can cause damage to the transfer plate. Therefore, as shown in FIG. 12, the rear plate wetting device in the embodiment of the present disclosure further includes a pressure regulator 23 connected with the uniforming roller 22 and configured for regulating a contact pressure between the uniforming roller 22 and the printing roller 5, so that the contact pressure between the uniforming roller 22 and the printing roller 5 is in a proper range, and the problem is avoided.

Although the disclosure has been described above in great detail with general descriptions and specific embodiments, on the basis of the disclosure, some modifications or improvements may be made, which is apparent to those skilled in the art. Therefore, all such modifications or improvements without departing from the spirit of the disclosure are within the scope of the claims of the disclosure.

The present application claims priority of the Chinese Patent Application No. 201510734300.7 filed on Nov. 2, 2015, the disclosure of which are incorporated herein by its reference in its entirety as part of the present application.

1. A transfer plate wetting system, comprising a first plate wetting device, the first plate wetting device including an alignment agent storage tank, an alignment agent solvent storage tank, a nozzle and a pipeline connector for communicating the alignment agent storage tank, the alignment agent solvent storage tank and the nozzle, the nozzle being configured to spray out alignment liquid including an alignment agent and an alignment agent solvent.

2. The transfer plate wetting system according to claim 1, wherein the pipeline connector includes a first liquid outlet pipeline, a second liquid outlet pipeline and a liquid mixing pipeline which are communicated with each other, wherein the first liquid outlet pipeline is connected to the alignment agent storage tank, and is configured to receive the alignment agent from the alignment agent storage tank; and the second liquid outlet pipeline is connected to the alignment agent solvent storage tank and is configured to receive the alignment agent solvent from the alignment agent solvent storage tank, and the liquid mixing pipeline is configured to receive the alignment agent from the first liquid outlet pipeline and the alignment agent solvent from the second liquid outlet pipeline to form the alignment liquid and convey the alignment liquid to the nozzle.

3. The transfer plate wetting system according to claim 2, further comprising: a transfer plate conveying unit, configured to carry and convey a transfer plate.

4. The transfer plate wetting system according to claim 2, wherein the first plate wetting device further includes a first flow regulator and a second flow regulator, wherein the first flow regulator is arranged on the first liquid outlet pipeline, and is configured to regulate flow of the alignment agent; and the second flow regulator is arranged on the second liquid outlet pipeline, and is configured to regulate flow of the alignment agent solvent.

5. The transfer plate wetting system according to claim 4, wherein the first plate wetting device further includes a controller and the controller is respectively connected with the first flow regulator and the second flow regulator.

6. The transfer plate wetting system according to claim 2, wherein the first plate wetting device further includes a first valve and a second valve; and the first valve is arranged on the first liquid outlet pipeline and is configured to switch on/off the first liquid outlet pipeline, and the second valve is arranged on the second liquid outlet pipeline, and is configured to switch on/off the second liquid outlet pipeline.

7. The transfer plate wetting system according to claim 1, wherein the first plate wetting device further includes a first liquid level sensor connected with the alignment agent storage tank and a second liquid level sensor connected with the alignment agent solvent storage tank, wherein the first liquid level sensor is configured to detect a liquid level of the alignment agent in the alignment agent storage tank, and the second liquid level sensor is configured to detect a liquid level of the alignment agent solvent in the alignment agent solvent storage tank.

8. The transfer plate wetting system according to claim 2, wherein the liquid mixing pipeline includes a first sub liquid mixing pipeline and a second sub liquid mixing pipeline, the first sub liquid mixing pipeline is positioned on upstream of the second sub liquid mixing pipeline, and the first plate wetting device further includes a pump positioned between the first sub liquid mixing pipeline and the second sub liquid mixing pipeline of the liquid mixing pipeline.

9. The transfer plate wetting system according to claim 3, wherein the transfer plate conveying unit includes a plurality of conveying rollers, rotating shafts of the plurality of conveying rollers are in parallel with each other, and supporting surfaces of the plurality of conveying rollers are positioned on a same plane.

10. The transfer plate wetting system according to claim 1, wherein the transfer plate wetting system further includes a second plate wetting device, and the second plate wetting device includes an infiltration liquid storage tank.

11. An alignment liquid transfer system, comprising the transfer plate wetting system according to claim 1 and an alignment liquid transfer device, wherein the alignment liquid transfer device includes a transfer plate and a printing roller, the transfer plate is configured to be wrapped on the printing roller, and the alignment liquid transfer device is configured to transfer the alignment liquid on the transfer plate onto a display substrate to be subjected to transfer printing.

12. The alignment liquid transfer system according to claim 11, further comprising a second plate wetting device, the second plate wetting device including an infiltration liquid storage tank configured to accommodate an infiltration liquid for infiltrating the transfer plate.

13. The alignment liquid transfer system according to claim 12, wherein the alignment liquid transfer device further includes a carrying table for placing the display substrate to be subjected to transfer printing, and the infiltration liquid storage tank is arranged on a transfer termination end side of the carrying table.

14. The alignment liquid transfer system according to claim 11, wherein the second plate wetting device further includes a uniforming roller, and is configured to be tangent to the printing roller.

15. The alignment liquid transfer system according to claim 14, wherein the second plate wetting device further includes a pressure regulator, wherein the pressure regulator is connected with the uniforming roller, and is configured for regulating a contact pressure between the uniforming roller and the printing roller.
